(19) United States
(12) Patent Application Publication
(10) Pub. No.: US 2026/0309592 A1
(43) Pub. Date: Oct. 8, 2026

(54) DIAPHRAGM-REGULATED CAPILLARY FLOW CONTROLLER, SAMPLING ASSEMBLY, AND METHODS FOR SAMPLING

(71) Applicant: RESTEK CORPORATION, Bellefonte, PA (US)

(72) Inventors: Jason S. HERRINGTON, Centre Hall, PA (US); Gary STIDSEN, State College, PA (US)

(21) Appl. No.: 19/482,944

(22) PCT Filed: Jun. 6, 2024
(86) PCT No.: PCT/US2024/032688

§ 371 Date: Nov. 10, 2025

Related U.S. Application Data
(60) Provisional application No. 63/471,348, filed on Jun. 6, 2023.

(51) Int. Cl. G01N 1/22; G01N 1/24

(52) U.S. Cl. CPC G01N 1/2273; G01N 1/24; G01N 2001/248

(57) ABSTRACT

A diaphragm-regulated capillary flow controller is disclosed including a diaphragm-regulated flow controller and a capillary flow controller connected to and in fluid communication with the diaphragm-regulated flow controller. A sampling assembly is disclosed, including the diaphragm-regulated capillary flow controller and a sampling vessel having an inlet in fluid communication with the diaphragm-regulated flow controller through the capillary flow controller. A method for sampling is disclosed, including disposing the sampling assembly in an air sampling location with the sampling vessel being evacuated, setting a flow rate of the diaphragm-regulated capillary flow controller to a rate of up to about 0.5 mL/min, opening a valve blocking fluid communication of the sampling vessel with an atmosphere to be sampled, collecting a sample for a duration of more than one week, and closing the valve.

### RELATED APPLICATIONS

This application claims the benefit of and priority to U.S. Provisional Patent Application No. 63/471,348, filed Jun. 6, 2023, entitled “Diaphragm-Regulated Capillary Flow Controller, Sampling Assembly, and Method for Sampling,” which is hereby incorporated by reference in its entirety.

### FIELD OF THE INVENTION

This application is directed to a flow controller, a sampling assembly, and a method for sampling. In particular, this application is directed to a diaphragm regulated capillary flow controller, a sampling assembly having a diaphragm regulated capillary flow controller, and a method for sampling using a diaphragm regulated capillary flow controller.

### BACKGROUND OF THE INVENTION

Airborne very volatile organic compounds (“VVOC”s), which have boiling points (“BP”) from less than 0 to 49° C.; volatile organic compounds (“VOC”s), which have BPs from 50-260° C.; and semi volatile organic compounds (“SVOC”s), which have BPs from 261-400° C., and represent compounds in the C1-C10 range, are often sampled into collection/storage vessels such as bags (e.g., TEDLAR®, SAMPLEPRO®, FLEXFOIL®, SUPEL™-INERT, ALTEF®), stainless steel canisters (electropolished (e.g., TO-CAN®) and silicon-lined (e.g., SILCOCAN™ SILONITE™)]), glass bottles (e.g., BOTTLE-VAC™), and high-pressure cylinders. Samples are often actively collected into bags via sampling pumps (referred to as an “active” sample), while canisters, glass bottles, and high-pressure cylinders are often pulled under vacuum, which is then used to passively collect the samples (referred to as a “passive” sample). After sample collection, the vessels are shipped from the field to an analytical laboratory where an aliquot of sample is then removed from the vessels. Since the samples are complex in nature, the aliquot is often separated by chromatographic means (e.g., gas chromatography (“GC”), liquid chromatography (“LC”)) and then analyzed with a calibrated detector (e.g., flame ionization detector (“FID”), mass spectrometry (“MS”)).

Samples may be collected in a grab or “time-integrated mode.” A “grab” sample is collected from an atmosphere or source in a relatively short time period (i.e., generally on the order of seconds). For example, opening the valve on an evacuated (i.e., under vacuum) canister, without a designated flow restrictor, will result in the canister filling in about 10-30 seconds. A “time-integrated sample” is collected over a relatively longer period (e.g., 24 hours to 2 weeks) and represents the average concentration for that sampling time interval (see Herrington, Jason Sandor Ambient Air Sampling with Whole-Air, In-Field Concentration and Particulate Matter (PM) Methodologies in Monitoring of Air Pollutants: Sampling, Sample Preparation and Analytical Techniques, Patricia B. C. Forbes (Ed.), 2015).

Critical orifices are the gold standard for reducing flow rates to collect a passive time-integrated sample, where flow rate is principally a function of orifice size. This approach is generally regarded as providing stable flows until the vessel is almost 50% full. However, when a critical orifice is coupled with a mechanical diaphragm flow controller, which can maintain a near-constant sample flow rate over time, the vessel may be filled to about ⅚ full (about 84 kPa) (see METHOD TO-15 Determination of Volatile Organic Compounds (VOCs) In Air Collected In Specially-Prepared Canisters And Analyzed By Gas Chromatography/Mass Spectrometry (GC/MS), Cincinnati, OH, U.S. EPA, 1999) with stable flow. Current critical orifice and diaphragm flow controller (“DFC”) technology is only capable of achieving flows of 0.5 mL/min, which equates to 10,200 min of sampling until a 6 L canister (a common industry standard size) is ⅚ full. Seven days of sampling (i.e., 10,200 min) does not meet the current industry desires.

There is a need in the industry for an ability to sample over longer durations with 6 L canisters (e.g., 2 weeks), as this provides more meaningful time-weighted concentrations for environmental health experts, by minimizing the impacts of temporal variations associated with environmental conditions (e.g., wind, temperature, humidity, and pressure), and minimizes transportation, shipping, and handling, as the shipping costs associated with shipping 6 L canisters across the globe is significant. However, more than 25 years after a need for lower flow rates to achieve longer sampling was recognized in U.S. Pat. No. 5,621,180, the industry is unable to reliably sample below 0.5 mL/min.

To meet industry needs, the capillary sampling flow controller (“CSFC”) was developed, which may further be abbreviated as a capillary flow controller (“CFC”). The CFC device is capable of constant flows of 0.23 mL/min up to 40-65% of the canister fill, depending on the conditions. Subsequently, the National Institute of Occupational Safety and Health (NIOSH) published their Volatile Organic Compounds, C1 to C10, Canister Method 3900 (see Manual of Analytical Method (NMAM), Fifth Edition, NIOSH, 2018 3900). Although the NIOSH method was able to demonstrate even lower sampling rates (i.e., 0.06 mL/min) for a CFC, the method recommended a ⅓ fill (about 30.4 kPa), as the uncertainties associated with the sampling and subsequent sample handling/processing were too significant at the 40-65% fill level. The ⅓ fill volume is the reason why CSFCs have not been significantly adopted in the industry.

Typical post sampling processing of evacuated vessels requires the end user to fill the canister with clean air or nitrogen to 0 kPa absolute or above, as the sample cannot be easily removed from the vessel for analysis if it is still under vacuum. This practice holds true regardless of canister fill volume (i.e., about 33-85%). The act of filling the vessel means the sample inside the has been diluted from the original concentration. Therefore, when a canister is filled only to ⅓ fill, the post sampling act of filling the canister with clean air or nitrogen to 0 kPa absolute or above (i.e., pressured) makes it so that the sample in the vessel may be removed. The existing NIOSH method and the U.S. Pat. No. 5,621,180 method addressed above were both clearly written around air sampling for industrial hygiene environments where concentrations of concern are in the high ppbv to low ppmv levels. High ppbv to low ppmv samples may be easily diluted, as the final concentration is still well above current air pre-concentrator GC-MS combinations which are used to analyze the samples. However, the dilution of ambient samples, which are high pptv to low ppbv levels, are already at the limit of detection for most instruments, and dilution of a canister with such a sample filled to ⅓ is not practical.

Current DFCs (combined with a critical orifice) allow for the constant flow up to ⅚ vessel fill. However, because they are based on critical orifices, they cannot achieve flows rates less than 0.5 mL/min. Current CFCs can achieve flow rates below 0.5 mL/min; however, the fill rates only remain constant up to ⅓ vessel fill.

Referring to FIG. 1, a critical orifice achieves constant low flow when the outlet pressure (P2) of the orifice is less than or equal to 0.528 that of the inlet pressure (P1). The flow is considered to have reached a critical state at this point, whereby increasing P1 and/or decrease P2 will not increase the volumetric flow rate. However, increasing P1 may increase the mass flow rate, as the density of the gas has increased. If the ratio of P2/P1 raises above 0.528, then the flow rate is no longer critical and flow decreases. In vessel sampling under vacuum this inflection point is 53.5 kPa absolute. Although not discussed in the known literature, the sonic flow achieve in a critical orifice scenario is believed to be turbulent flow due to the shock wave.

Referring to FIG. 2, a critical orifice affixed to a DFC maintains a constant sample flow over a time period, despite changes in vessel vacuum. The critical orifice acts as a flow restrictor upstream of a constant back pressure (i.e., vacuum in the vessel). This constant back pressure is established by the balance between the mechanical spring rate of the diaphragm and the pressure differential across the diaphragm. The latter is established by the pressure difference between the atmospheric pressure, the vacuum in the vessel, and the flow through the critical orifice. The net result is a constant flow, up to ⅚ vessel fill (i.e., 84.7 kPa consumed out of the available 101.6 kPa), and then the sampling rate drops off. The critical orifice determines the flow range. The adjustable piston is used to set a specific, fixed flow rate within the flow range. An adjustment to the position of the piston changes the back pressure, which changes the pressure differential across the critical orifice. If the piston is lowered away from the diaphragm, the flow rate will increase. If the piston is raised toward the diaphragm, the flow rate will decrease.

### BRIEF DESCRIPTION OF THE INVENTION

Devices according to the present disclosure adapt CFC to a DFC, which reduces flow to less than 0.5 mL/min up to and in excess of ⅚ vessel fills and will be referred to as diaphragm-regulated capillary flow controllers (“DCFC”s).

In one exemplary embodiment a diaphragm-regulated capillary flow controller includes a diaphragm-regulated flow controller and a capillary tube connected to and in fluid communication with the diaphragm-regulated flow controller.

In another exemplary embodiment, a sampling assembly includes a diaphragm-regulated capillary flow controller including a diaphragm-regulated flow controller and a capillary tube connected to and in fluid communication with the diaphragm-regulated flow controller, and a sampling vessel having an inlet in fluid communication with the diaphragm-regulated flow controller through the capillary tube.

In another exemplary embodiment, a method for sampling includes disposing a sampling assembly in an air sampling location, the sampling assembly including a diaphragm-regulated capillary flow controller including a diaphragm-regulated flow controller and a capillary tube connected to and in fluid communication with the diaphragm-regulated flow controller, and a sampling vessel having an inlet in fluid communication with the diaphragm-regulated flow controller through the capillary tube, the sampling vessel being evacuated. The method further includes setting a flow rate of the diaphragm-regulated capillary flow controller to a rate of up to about 0.5 mL/min, opening a valve blocking fluid communication of the sampling vessel with an atmosphere to be sampled, collecting a sample for a duration of more than one week, and closing the valve.

Further aspects of the subject matter of the present disclosure are provided by the following clauses:

A diaphragm-regulated capillary flow controller, comprising a diaphragm-regulated flow controller and a capillary flow controller connected to and in fluid communication with the diaphragm-regulated flow controller.

The diaphragm-regulated capillary flow controller of any preceding clause, wherein flow through the diaphragm-regulated capillary flow controller is laminar and sub-sonic.

The diaphragm-regulated capillary flow controller of any preceding clause, wherein the capillary flow controller has a native flow rate at least about four times higher than a targeted flow rate of the diaphragm-regulated capillary flow controller.

The diaphragm-regulated capillary flow controller of any preceding clause, wherein the capillary flow controller includes capillary tube having a length of at least 1 cm.

The diaphragm-regulated capillary flow controller of any preceding clause, wherein the length of the capillary tube is 1 cm to 1 km.

The diaphragm-regulated capillary flow controller of any preceding clause, wherein the capillary flow controller includes a capillary tube having an internal diameter of at least 0.01 mm.

The diaphragm-regulated capillary flow controller of any preceding clause, wherein the internal diameter of the capillary tube is 0.01 mm to 2 mm.

The diaphragm-regulated capillary flow controller of any preceding clause, wherein the capillary flow controller includes a capillary tube formed from fused silica.

The diaphragm-regulated capillary flow controller of any preceding clause, wherein the fused silica is deactivated.

The diaphragm-regulated capillary flow controller of any preceding clause, wherein the capillary flow controller includes a capillary tube formed from stainless steel.

The diaphragm-regulated capillary flow controller of any preceding clause, wherein the stainless steel is deactivated.

The diaphragm-regulated capillary flow controller of any preceding clause, wherein the capillary flow controller is encased in an epoxy medium within an enclosure.

The diaphragm-regulated capillary flow controller of any preceding clause, wherein diaphragm-regulated capillary flow controller is free from critical orifices.

A sampling assembly, comprising a diaphragm-regulated capillary flow controller including a diaphragm-regulated flow controller and a capillary flow controller connected to and in fluid communication with the diaphragm-regulated flow controller and a sampling vessel having an inlet in fluid communication with the diaphragm-regulated flow controller through the capillary flow controller.

The sampling assembly of any preceding clause, wherein the sampling vessel is formed of a material selected from the group consisting of aluminum, stainless steel, glass, quartz crystal, and combinations thereof.

The sampling assembly of any preceding clause, wherein the sampling vessel is deactivated.

The sampling assembly of any preceding clause, wherein the sampling vessel has a volume of at least 25 mL.

The sampling assembly of any preceding clause, wherein the diaphragm-regulated capillary flow controller maintains constant flow from 0% to 85% of a volume of the sampling vessel.

A method for sampling, comprising disposing a sampling assembly in an air sampling location, the sampling assembly including a diaphragm-regulated capillary flow controller including a diaphragm-regulated flow controller and a capillary flow controller connected to and in fluid communication with the diaphragm-regulated flow controller and a sampling vessel having an inlet in fluid communication with the diaphragm-regulated flow controller through the capillary flow controller, the sampling vessel being evacuated and setting a flow rate of the diaphragm-regulated capillary flow controller to a rate of up to about 0.5 mL/min, opening a valve blocking fluid communication of the sampling vessel with an atmosphere to be sampled, collecting a sample for a duration of more than one week, and closing the valve.

The method of any preceding clause, further including collecting the sample at more than 85% of a volume of the sampling vessel.

### BRIEF DESCRIPTION OF THE DRAWINGS

FIG. 1 is schematic view of sonic velocity achieved in critical flow.

FIG. 2 is a cross-sectional schematic view of a DFC.

FIG. 3 is a cross-sectional schematic view of a DCFC in which a CFC is connected to a DFC, according to an embodiment of the present disclosure.

FIG. 4 is a cross-sectional schematic view of a DCFC in which a CFC is connected to a DFC and in which the CFC is disposed within a housing, according to an embodiment of the present disclosure.

FIG. 5 is graph of flow in a DCFC as a function of vessel pressure at different set flow speeds, according to an embodiment of the present disclosure.

FIG. 6 is graph of flow in a DFC combined with a critical orifice as compared to a DCFC as a function of vessel pressure measuring the inflection points of each, according to an embodiment of the present disclosure.

Wherever possible, the same reference numbers will be used throughout the drawings to represent the same parts.

### DETAILED DESCRIPTION OF THE INVENTION

A novel flow controller is described for the passive sampling of VVOCs, VOCs, and SVOCs in the C1-C10 range into collection/storage vessels such as stainless-steel canisters, silicon-lined cannisters, glass bottles, and high-pressure cylinders, via a vacuum state. The DCFC affords end users the following two significant advantages over current technologies: (1) a flow rate as low as 0.05 mL/min, which is an order magnitude lower than any current critical orifice may deliver; and (2) constant flow rates (i.e., ±10% flow deviation) through a vacuum range of 101.6 kPa to 16.9 kPa, which is suitable for a the user to utilize about 85% of the volume of a storage vessel.

“kPa absolute” is used herein analogously to psia, meaning relative to absolute vacuum.

“Critical Flow,” which is often referred to as “choked flow,” as used herein is flow through an orifice's minimum area that is maintained at the speed of sound (i.e., Mach 1), at standard conditions.

“Standard Conditions” as used herein are atmospheric pressure at 101 kPa and temperature at 0° C., according to the National Institute of Standards and Technology (“NIST”), the international union of Pure and Applied Chemistry (“IUPAC”), and the International Organization for Standardization (“ISO”) 10780.

“Critical Orifice” as used herein is a hole through which air passively flows through under vacuum at a velocity of at least about Mach 1.

“Air” and “air samples” as used herein may be atmospheric air or other gases capable of being collected with a canister or other vessel.

“Canister” and “vessel” as used herein means any container capable of housing a volume of air or gas.

“Native flow” as used herein refers to unaltered flow through a conduit.

“Q” as used herein indicates flow rate, where “Qₙ” indicates flow rate at time “n” and “Q₀” indicates flow rate at the start time where n=0. “Q” is measured with the use of inline mass flow meters.

“About” as used herein indicates a variance of up to 10% of the value so modified, and specifically includes the absolute value as well, such that “about 2” discloses both a range from 1.8 to 2.2 as well as 2.

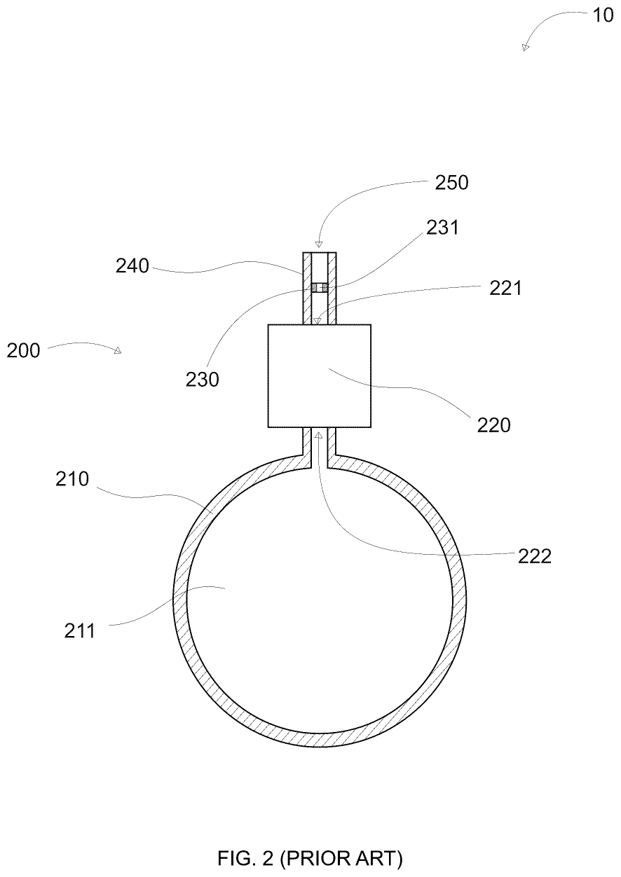

Referring to FIG. 2, in known CSFC 200 devices, a DFC 220 is adapted to be attached to a sampling vessel 210 having a sample vessel volume 211. The DFC 220 includes a flow controller inlet 221 and a flow controller outlet 222. The DFC 220 is connected to the sampling vessel 210 through the flow controller outlet 222 and is connected to a flow restrictor 230 through the flow controller inlet 221. The flow restrictor 230 includes a critical orifice diameter 231. The flow restrictor 230 is disposed downstream of a CSFC inlet 250 and upstream of the flow controller inlet 221 (upstream considered relative to filling the sampling vessel 210). The flow restrictor 230 may be disposed in a conduit 240. DFC 220 devices are known in the art and are described in U.S. Patent Application Publication No. 2021/0325357A1, the disclosure of which are incorporated herein as if fully reinstated herein.

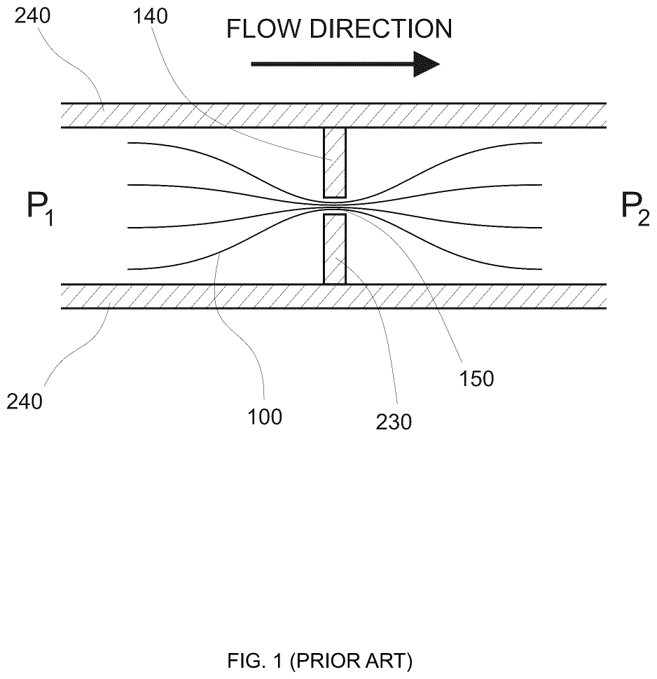

Referring to FIG. 1, a flow schematic shows the flow 100 of gas through a critical orifice 150 of a flow restrictor 230 in a conduit 240.

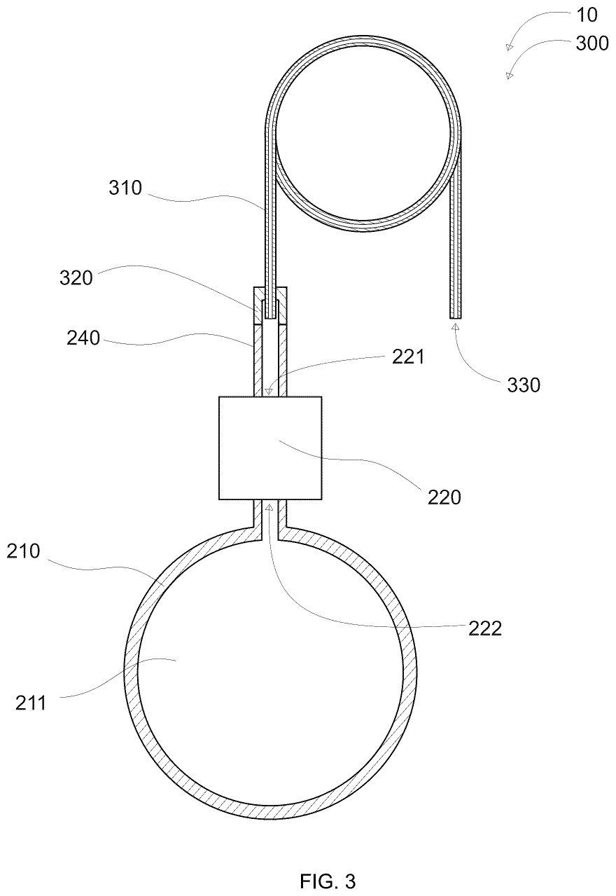

Referring to FIG. 3, in one embodiment, a DCFC 300 includes a CFC 310 connected to and in fluid communication with a DFC 220 (the CFC 310 is upstream relative to the DFC 220 which is upstream relative to a sampling vessel 210 to which the DFC 220 is attached, upstream being considered relative to filling the sampling vessel 210). The CFC 310 includes a DCFC inlet 330 disposed at an upstream end of the CFC 310. The CFC 310 may further include a connector 320 at a downstream end of the CFC 310 for attaching to a flow controller inlet 221 of a DFC 220, optionally through a conduit 240 extending from the flow controller inlet 221.

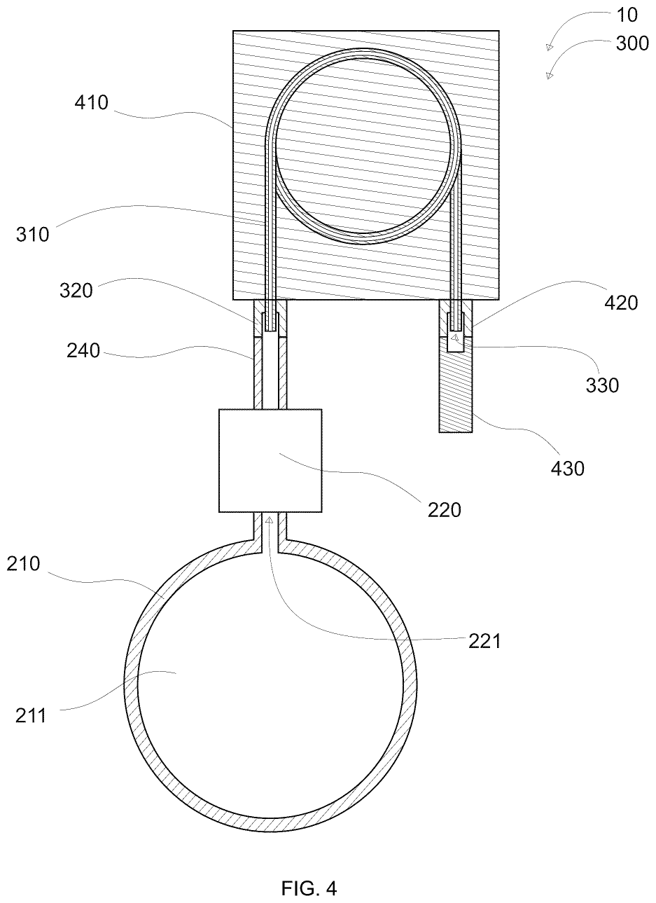

Referring to FIG. 4, in a further embodiment, the DCFC 300 includes a CFC enclosure 410 in which the CFC 310 is disposed. The CFC 310 may be attached to the CFC enclosure 410 with a connector 420 and may include a filter 430 disposed upstream of the DCFC inlet 330. The CFC 310 may be encased in epoxy or another space filling medium within the enclosure 410 or the CFC 310 may be isolated from contact within the enclosure other than at the connector downstream 320 and upstream connector 420.

In one embodiment, a CFC 310 with fused silica capillary tubing, compression fittings, and the CFC enclosure 410 is suitable for being connected to a DFC 220 with a female quick connect port to form the DCFC 300.

The DCFC 300 may incorporate the CFC 310 to achieve the low flow. Unlike a critical orifice 150, the flow rate of a CFC 310 is a function of the tubing length and internal diameter (ID), whereas the flow of a critical orifice is only a function of ID. While both a CFC and critical orifice have the rate limiting step of ID (i.e., there is only such a small ID one can reliably, readily, and reproducibly generate), the CFC 310 may overcome this rate limiting step with tubing length. Theoretically, tubing length may be increased at infinitum with a concurrent reduction in flow headed to a point of 0 mL/min.

The CFC 310 achieves low flow as a function of the tubing length and internal diameter, whereby the flow is subsonic and laminar. In addition, the relationship between upstream pressure and downstream pressure takes place across the length of the tubing, and is therefore a gradient, as opposed to the step function relationship of a critical orifice 150. Without being bound by theory, it is believed that the combination of pressure gradient with non-turbulent (i.e., laminar) sub-sonic flow in the DCFC 300 achieves a synergy such that the diaphragm in the DFC 220 is able to unexpectedly maintain the necessary pressure differential for longer (as compared to a DFC 220 alone or the CSFC 200) and hence the DCFC 300 may have a greater vessel fill than a DFC 220 (i.e., a vessel fill of about 90% rather than about 83% for a DFC 220).

The DCFC 300 is suitable for diaphragm-regulated (i.e., constant), laminar, subsonic flow at 0.05 mL/min; up-to and in excess of ⅚ fill, which meets a long-felt need in the industry. Flow through the DCFC 300 may be laminar, sub-sonic, or both laminar amd sub-sonic.

The CFC 310 may include a capillary tube having any suitable length, including, but not limited to, at least 1 cm, alternatively a length between 1 cm and 1 km, alternatively between 1 cm and 10 cm, alternatively between 5 cm and 50 cm, alternatively between 10 cm and 1 m, alternatively between 50 cm and 10 m, alternatively between 1 m and 100 m, alternatively between 10 m and 500 m, or any sub-range or combination thereof. The capillary tube may have any suitable internal diameter, including, but not limited to, an internal diameter of at least 0.01 mm, alternatively 0.01 mm to 2 mm, alternatively 0.01 mm to 0.1 mm, alternatively 0.05 mm to 0.5 mm, alternatively 0.1 mm to 1 mm, alternatively 0.5 mm to 1.5 mm, alternatively 1 mm to 2 mm, or any sub-range or combination thereof.

The CFC 310 may be formed of any suitable material, including, but not limited to, fused silica, borosilicate, stainless steel, or combinations thereof. The material of the CFC 310 may be deactivated or undeactivated or may be chemically passivated or unpassivated.

The DFC 220 may include a rigid diaphragm. The rigid diaphragm may maintain constant vacuum downstream of the CFC 310.

In one embodiment, a sampling assembly 10 includes the DCFC 300 and a sampling vessel 210. The sampling vessel 210 may be formed of any suitable material, including, but not limited to, aluminum, stainless steel, glass, quartz crystal, or combinations thereof. The sampling vessel 210 may be deactivated or undeactivated. The sampling vessel 210 may have any suitable volume, including, but not limited to, a volume of at least 25 mL, alternatively a volume of at least 50 mL, alternatively at least 100 mL, alternatively at least 500 mL, alternatively at least 1 L, alternatively at least L, alternatively at least 6 L, alternatively about 6 L.

The DCFC 300 may maintain constant flow from 0% to 85% of a volume of the sampling vessel 210, alternatively 0% to 90% of the volume of the sampling vessel 210, alternatively 0% to 95% of the volume of the sampling vessel 210, alternatively 0% to 98% of the volume of the sampling vessel 210.

In one embodiment, the CFC 310 has a native flow at least about four times higher than a targeted flow rate of the DCFC 300 to establish a pressure differential across the DFC 220 suitable for constant (i.e., Qₙ/Q₀>0.901 for ⅚ vessel fill) laminar and subsonic flow. The CFC 310 may have a native flow higher that a targeted flow rate of the DCFC 300 by any suitable factor that establishes a pressure differential across the DFC 220 suitable for constant (i.e., Qₙ/Q₀>0.901 for ⅚ vessel fill) laminar and subsonic flow, including, but not limited to, a factor of at least 3.3, alternatively at least 3.4, alternatively at least 3.5, alternatively at least 3.6, alternatively at least 3.7, alternatively at least 3.8, alternatively at least 3.9, alternatively at least 4.0, alternatively at least 4.1, alternatively at least 4.2, alternatively at least 4.3, alternatively at least 4.4, alternatively at least 4.5, alternatively at least 4.6, alternatively at least 4.7, alternatively at least 4.8, alternatively at least 4.9, alternatively at least 5.0, alternatively at least 5.1, alternatively at least 5.2, alternatively at least 5.3, alternatively at least 5.4, alternatively at least 5.5, alternatively at least 5.6, alternatively at least 5.7, alternatively at least 5.8, alternatively at least 5.9, alternatively at least 6.0, alternatively at least 6.1, alternatively at least 6.2, alternatively at least 6.3, alternatively at least 6.4, alternatively at least 6.5, alternatively at least 6.6, alternatively at least 6.7, alternatively at least 6.8, alternatively at least 6.9, alternatively at least 7.0, alternatively between 3.5 to 4.5, alternatively between 4.0 to 5.0, alternatively between 4.5 to 5.5, alternatively between 5.0 to 6.0, alternatively between 5.5 to 6.5, alternatively between 6.0 to 7.0, alternatively between 3.5 to 10.0, alternatively between 4.0 to 10.0.

In one embodiment, a method for sampling includes disposing the sampling assembly 10 in an air sampling location, the sampling vessel 210 being evacuated, setting a flow rate of the DCFC 300 to a rate of up to about 0.5 mL/min, opening a valve blocking fluid communication of the sampling vessel 210 with an atmosphere to be sampled, collecting a sample for a duration of more than one week, and closing the valve.

### EXAMPLES

For the examples disclosed herein, a 12.7 cm length of 0.05 mm inner diameter fused silica tubing was used, the native flow of this tubing was verified to be 0.20 mL/min, this length of tubing was placed in a protective box with appropriate compression fittings, the box with tubing was affixed to a DFC to form a DCFC which was affixed to a vacuum source, the flow of the DCFC was adjusted to 0.05 mL/min, 0.10 mL/min, or 0.15 mL/min, as verified by a calibrated flow meter, and the flow of the DCFC was recorded as a function of canister pressure.

In an exemplary calculation, A 12.7 cm length of capillary having a native flow of 2.0 mL/min would have a velocity of about 170 cm/s, which is two orders of magnitude lower than the speed of sound (34,000 cm/s in dry air at 20° C. and 101 kPa). In contrast, a capillary flow controller would require relatively large internal diameter of 0.53 mm and length of 7.04 cm to achieve a velocity of 34,419 cm/sec, breaking the speed of sound. However, this same capillary flow controller would have a flow rate of 1,104 mL/min, which is outside the scope of low flow time-integrated sampling (i.e., <0.50 mL/min). However, critical orifices may readily achieve such high sampling rates in excess of the speed of sound.

TABLE 1
Flow Speed Parameters

| | Low | High |
|---|---|---|
| Capillary Internal Diameter(mm) | 0.05 | 0.53 |
| Tubing Length (cm) | 12.7 | 7.04 |
| Q (cm³/min) | 0.2 | 1,104 |
| V (cm/sec) | 170 | 34,419 |

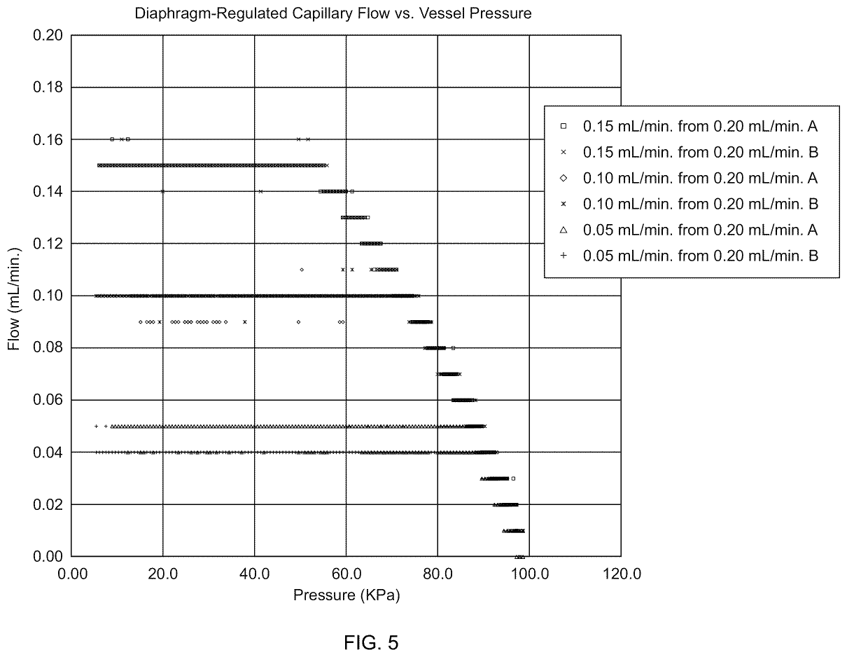

Referring to FIG. 5, a constant 0.05 mL/min flow was achieved from 0 to >82.7 kPa absolute. This correlates to >⅚ of canister fill, as the atmospheric pressure was 97.9 kPa absolute (i.e., 82.7/97.9 kPa absolute). Pressure is used as the direct measurement of canister fill; 0 kPa absolute is full vacuum and 101.4 kPa absolute is atmospheric pressure at sea level and 20° C. The flow was deemed to be stable until the flow rate dropped by 20% of the starting flow (e.g., 0.05 mL/min dropping to 0.04 mL/min). In contrast, for flow rates at 0.10 mL/min, or 0.15 mL/min, the flow rate dropped by 20% at less than ⅚ of cannister fill, demonstrating that constant laminar subsonic flow is achieved when the native flow through the CFC is at least about 4 times higher than the targeted flow rate through the DCFC.

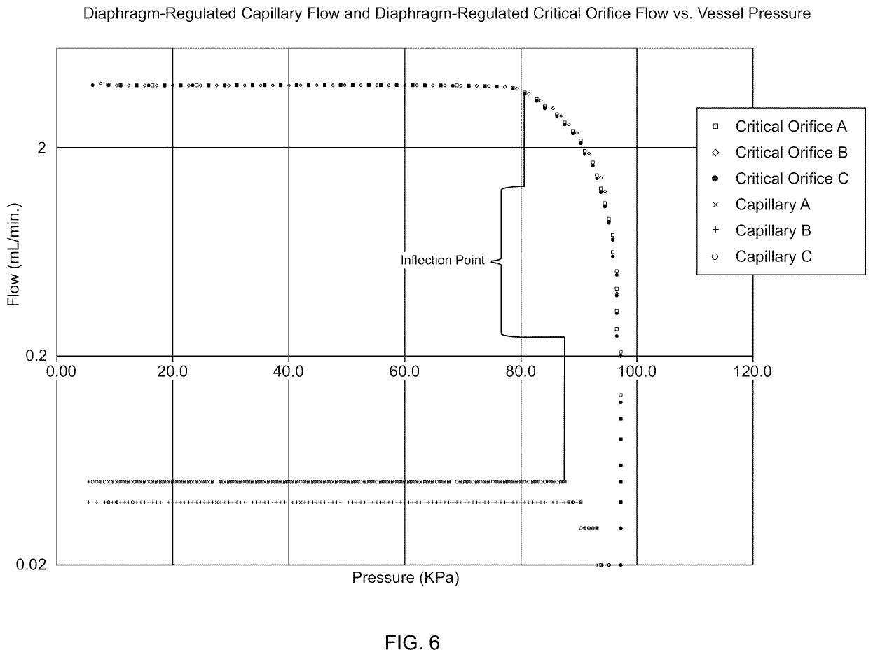

Referring to FIG. 6, an inflection point is defined as the point at which the Qₙ/Q₀<0.901, which was 80.7 kPa absolute (i.e., 83% canister fill with a background pressure of 97.2 kPa absolute) for the critical orifice on a DFC and 88.9 kPa absolute (i.e., 90% canister fill with a background pressure of 97.2 kPa absolute) for the DCFC. The increase in inflection point for DCFC versus critical orifice flow is an unexpected and highly beneficial result.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A diaphragm-regulated capillary flow controller, comprising:
a diaphragm-regulated flow controller; and
a capillary flow controller connected to and in fluid communication with the diaphragm-regulated flow controller.

2. The diaphragm-regulated capillary flow controller of claim 1, wherein flow through the diaphragm-regulated capillary flow controller is laminar and sub-sonic.

3. The diaphragm-regulated capillary flow controller of claim 1, wherein the capillary flow controller has a native flow rate at least about four times higher than a targeted flow rate of the diaphragm-regulated capillary flow controller.

4. The diaphragm-regulated capillary flow controller of claim 1, wherein the capillary flow controller includes capillary tube having a length of at least 1 cm.

5. The diaphragm-regulated capillary flow controller of claim 4, wherein the length of the capillary tube is 1 cm to 1 km.

6. The diaphragm-regulated capillary flow controller of claim 1, wherein the capillary flow controller includes a capillary tube having an internal diameter of at least 0.01 mm.

7. The diaphragm-regulated capillary flow controller of claim 6, wherein the internal diameter of the capillary tube is 0.01 mm to 2 mm.

8. The diaphragm-regulated capillary flow controller of claim 1, wherein the capillary flow controller includes a capillary tube formed from fused silica.

9. The diaphragm-regulated capillary flow controller of claim 8, wherein the fused silica is deactivated.

10. The diaphragm-regulated capillary flow controller of claim 1, wherein the capillary flow controller includes a capillary tube formed from stainless steel.

11. The diaphragm-regulated capillary flow controller of claim 10, wherein the stainless steel is deactivated.

12. The diaphragm-regulated capillary flow controller of claim 1, wherein the capillary flow controller is encased in an epoxy medium within an enclosure.

13. The diaphragm-regulated capillary flow controller of claim 1, wherein diaphragm-regulated capillary flow controller is free from critical orifices.

14. A sampling assembly, comprising:
a diaphragm-regulated capillary flow controller including:
a diaphragm-regulated flow controller; and
a capillary flow controller connected to and in fluid communication with the diaphragm-regulated flow controller; and
a sampling vessel having an inlet in fluid communication with the diaphragm-regulated flow controller through the capillary flow controller.

15. The sampling assembly of claim 14, wherein the sampling vessel is formed of a material selected from the group consisting of aluminum, stainless steel, glass, quartz crystal, and combinations thereof.

16. The sampling assembly of claim 15, wherein the sampling vessel is deactivated.

17. The sampling assembly of claim 14, wherein the sampling vessel has a volume of at least 25 mL.

18. The sampling assembly of claim 14, wherein the diaphragm-regulated capillary flow controller maintains constant flow from 0% to 85% of a volume of the sampling vessel.

19. A method for sampling, comprising:
disposing a sampling assembly in an air sampling location, the sampling assembly including:
a diaphragm-regulated capillary flow controller including:
a diaphragm-regulated flow controller; and
a capillary flow controller connected to and in fluid communication with the diaphragm-regulated flow controller; and
a sampling vessel having an inlet in fluid communication with the diaphragm-regulated flow controller through the capillary flow controller, the sampling vessel being evacuated; and
setting a flow rate of the diaphragm-regulated capillary flow controller to a rate of up to about 0.5 mL/min;
opening a valve blocking fluid communication of the sampling vessel with an atmosphere to be sampled;
collecting a sample for a duration of more than one week; and
closing the valve.

20. The method of claim 19, further including collecting the sample at more than 85% of a volume of the sampling vessel.
